(19) United States
(12) Patent Application Publication
(10) Pub. No.: US 2014/0146210 A1
(43) Pub. Date: May 29, 2014

(54) SOLID STATE IMAGING DEVICES AND METHODS USING SINGLE SLOPE ADC WITH ADJUSTABLE SLOPE RAMP SIGNAL

(71) Applicant: Samsung Electronics Co., Ltd., Suwon-si (KR)

(72) Inventors: Hyeokjong Lee, Yongin-si (KR); Byung-Jo Kim, Seoul (KR); Jaejung Park, Bucheon-si (KR); Yunjung Kim, Yongin-si (KR); Jinho Seo, Seoul (KR); Seung Hyun Lim, Yongin-si (KR); Seogheon Ham, Suwon-si (KR)

(73) Assignee: Samsung Electronics Co., Ltd., Suwon-si (KR)

(21) Appl. No.: 14/067,293

(22) Filed: Oct. 30, 2013

(30) Foreign Application Priority Data
Nov. 26, 2012 (KR) 10-2012-0134595

(51) Int. Cl. H04N 5/361

(52) U.S. Cl. CPC H04N 5/361
USPC 348/302

(57) ABSTRACT

A solid state imaging device includes a pixel array comprising a plurality of photoelectric conversion devices and an analog to digital conversion (ADC) circuit configured to convert an image signal received from the pixel array to a digital signal responsive to a ramp signal and a gain setting. The solid state imaging device further includes a ramp signal generator circuit configured to generate the ramp signal with a slope that varies responsive to a control signal and a dark level offset compensation circuit configured to generate the control signal responsive to the gain setting and a dark level measurement.

### CROSS-REFERENCE TO RELATED APPLICATIONS

This U.S. non-provisional patent application claims priority under 35 U.S.C. §119 of Korean Patent Application No. 10-2012-0134595, filed on Nov. 26, 2012, the entire contents of which are hereby incorporated by reference.

### BACKGROUND

The inventive subject matter relates to solid state imaging devices and methods of operating the same and, more particularly, to solid state imaging devices using single slope analog-to-digital conversion and methods of operating the same.

Solid state imaging devices are widely used in applications such digital photography, scanners, machine vision systems, surveillance cameras, etc. Examples of image sensors include CCD (charge coupled device) image sensors and CMOS (complementary metal oxide semiconductor) image sensors.

Image sensors commonly use a “column parallel” architecture in which pixel sensors are arranged in a square array having rows and columns. Pixel sensors in respective columns are connected to respective column data line and are selected row by row to drive the column data lines.

Image signals generated on the column data lines are typically converted into digital signals by an analog-to-digital conversion (ADC) circuit connected to the column data lines. Various techniques, such as dual correlated double sampling (CDS) using a single slope analog-to-digital conversion technique, may be used to generate a digital value from an analog image signal.

When operating an image sensor, it is often important to establish a signal level corresponding to a “dark” or “black” level, that is, a signal level corresponding to a dark scene (or a black scene). Image signals generated by an image sensor may be controlled based on the dark level established to improve quality of the image. In the case of a pixel output obtained after long exposure time in a low light environment, it may be difficult to perform dark offset compensation.

### SUMMARY

Some embodiments of the inventive subject matter provide a solid state imaging device including a pixel array including a plurality of photoelectric conversion devices and an analog to digital conversion (ADC) circuit configured to convert an image signal received from the pixel array to a digital signal responsive to a ramp signal and a gain setting. The solid state imaging device further includes a ramp signal generator circuit configured to generate the ramp signal with a slope that varies responsive to a control signal and a dark level offset compensation circuit configured to generate the control signal responsive to the gain setting and a dark level measurement.

The pixel array may include at least one optical black pixel and wherein the dark level measurement is generated from an output of the at least one optical black pixel.

The ADC circuit may include a comparator configured to generate a comparison signal responsive to the image signal and the ramp signal and a counter configured to generate a count signal responsive to the comparison signal. A gain of the comparator may be controlled by the gain setting. The dark level offset compensation circuit may be configured to cause the ramp signal generator to decrease the slope of the ramp signal responsive to a gain setting that increases the gain of the comparator and to increase the slope of the ramp signal responsive to a gain setting that decreases the gain of the comparator is decreased.

Some embodiments provide an apparatus including an analog to digital conversion (ADC) circuit configured to convert an image signal received from a photoelectric conversion device to a digital signal responsive to a ramp signal and a gain setting, a ramp signal generator circuit configured to generate the ramp signal with a slope that varies responsive to a control signal and a control circuit configured to determine the gain setting based on a dark level measurement and a conversion time period of the ADC circuit and to generate the control signal based on the determined gain setting.

Further embodiments provides methods of operating a solid state imaging device including a pixel array including a plurality of photoelectric conversion devices, an analog to digital conversion (ADC) circuit configured to convert an image signal received from the pixel array to a digital signal responsive to a ramp signal and a gain setting and a ramp signal generator circuit configured to generate the ramp signal with a slope and offset that varies responsive to a control signal. The methods include determining a first value for the ramp signal based on a dark level offset, determining a second value for the ramp signal based on a maximum saturation level of the input to the ADC circuit, determining a conversion time period of the ADC circuit, determining a gain for the ADC circuit based on the first value, the second value and the conversion time period, generating the ramp signal with a slope based on the determined gain, and converting the image signal into a digital signal responsive to the ramp signal using the ADC circuit with the determined gain.

### BRIEF DESCRIPTION OF THE FIGURES

Embodiments of the inventive subject matter will be described below in more detail with reference to the accompanying drawings. The embodiments of the inventive subject matter may, however, be embodied in different forms and should not be constructed as limited to the embodiments set forth herein. Rather, these embodiments are provided so that this disclosure will be thorough and complete, and will fully convey the scope of the inventive subject matter to those skilled in the art. Like numbers refer to like elements throughout.

FIG. 1 is a block diagram illustrating a CMOS image sensor in accordance with some embodiments of the inventive subject matter.

FIG. 2 illustrates in detail an arrangement of a pixel array illustrated in FIG. 1.

FIG. 3 is a detailed circuit diagram of a unit pixel illustrated in FIG. 2.

FIG. 4 is a block diagram illustrating an automatic dark level compensation circuit of FIG. 1.

FIG. 5 is a timing diagram illustrating automatic dark level compensation in accordance with some embodiments of the inventive subject matter.

FIG. 6 is a timing diagram related to an automatic dark level compensation in accordance with some other embodiments of the inventive subject matter.

FIG. 7 is a timing diagram illustrating automatic dark level compensation in accordance with FIG. 4.

FIG. 8 is a flow chart illustrating dark level compensation operations in accordance with FIG. 4.

FIG. 9 is a block diagram illustrating a camera according to some embodiments of the inventive subject matter.

FIG. 10 illustrates a digital camera application according to some embodiments of the inventive subject matter.

FIG. 11 illustrates a computing system application according to some embodiments of the inventive subject matter.

FIG. 12 illustrating a cellular phone application according to some embodiments of inventive subject matter.

### DETAILED DESCRIPTION

Some embodiments of inventive subject matter will be described more fully hereinafter with reference to the accompanying drawings, in which embodiments of the invention are shown. This inventive subject matter may, however, be embodied in many different forms and should not be construed as limited to the embodiments set forth herein. Rather, these embodiments are provided so that this disclosure will be thorough and complete, and will fully convey the scope of the inventive subject matter to those skilled in the art. In the drawings, the size and relative sizes of layers and regions may be exaggerated for clarity. Like numbers refer to like elements throughout.

A digital single lens reflex (DSLR) camera having an image sensor may have a bulb mode as one of its shooting modes. A bulb mode may be used to obtain an image which changes with time in low illumination and is often used when shooting a trace image of a star in the sky or a headlight of vehicle. In this case, a shutter of a camera is opened for a user-determined time and a long exposure time may be provided.

In the case of a pixel output of an image sensor obtained after long exposure time, it is desirable to remove a dark offset due to a dark current from the pixel output of the image sensor.

In a typical CMOS image sensor (CIS) that uses a dual CDS single slope ADC, a method of simply subtracting a dark offset from a photo signal has been used to compensate for dark offset. Since the maximum value of the photo signal may be as small as the dark offset, it may be insufficient to compensate the dark offset by only subtracting the dark offset from the obtained photo signal. Subtracting the dark offset from the photo signal may result in analog-to-digital (A/D) conversion of a value larger than the maximum value of the photo signal. The typical dark offset removal method may cause a burden or an overhead for a circuit constituting the image sensor.

Some embodiments of the inventive subject matter can reduce or minimize a burden of the circuit by operating the circuit in a full range of the photo signal considering the dark offset and gain. In some embodiments of the inventive subject matter, the maximum dynamic range may be automatically obtained depending on an operation of the circuit.

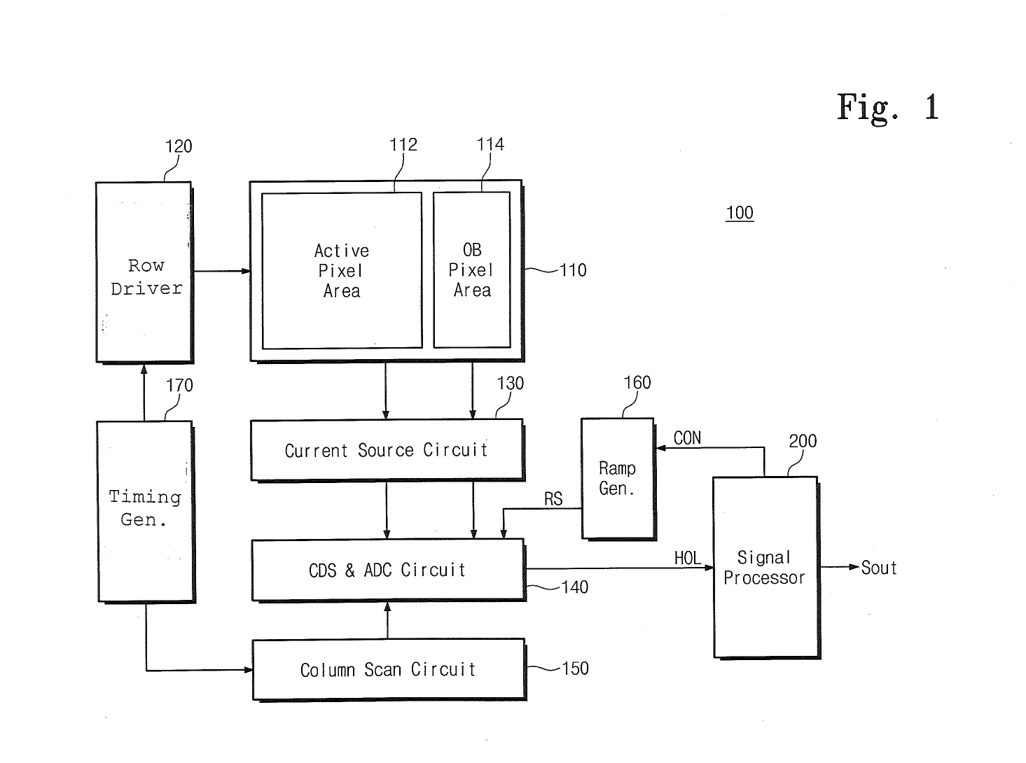

FIG. 1 is a block diagram illustrating the constitution of a CMOS image sensor in accordance with some embodiments of the inventive subject matter.

Referring to FIG. 1, the CMOS image sensor 100 includes a pixel array 110, a row driver 120, a current source circuit 130, a correlated double sampling (CDS) and analog digital converter (ADC) circuit 140, a column scan circuit 150, a ramp signal generator 160 and a timing generator 170.

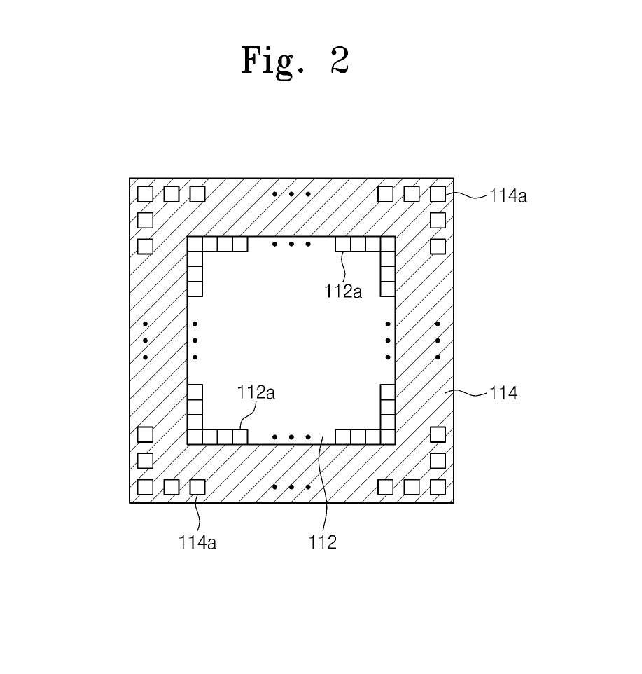

The pixel array 110, as illustrated in FIG. 2, may include an active pixel area and an optical black pixel area.

FIG. 2 is an illustrative drawing illustrating a detailed arrangement of a pixel array illustrated in FIG. 1.

Referring to FIG. 2, the pixel array 110 may include an active pixel area 112 and an optical black pixel area 114.

The active pixel area 112 includes a plurality of active pixels 112a, which include photoelectric conversion devices that generate active signals corresponding to wavelengths of light. Each of the active pixels 112a may include a color filter to pass specific wavelengths of light. The color filter may be one of a red filter passing wavelengths of a red region among wavelengths of a visible light region, a green filter passing wavelengths of a green region among wavelengths of a visible light region and a blue filter passing wavelengths of a blue region among wavelengths of a visible light region. The color filter may be one of a cyan filter, a yellow filter and a magenta filter.

The optical black pixel area 114 includes a plurality of optical black pixels 114a, which also include photoelectric conversion devices. Each of the optical black pixels 114a blocks out incident light to generate an optical black signal representing a dark level. At least some of the optical black pixels 114a may include an optical sensing device, such as a photo diode, a pinned photo diode or a photo gate. Some of the optical black pixels 114a may not include the optical sensing device.

Referring back to FIG. 1, the timing generator 170 generates a timing signal in response to a control signal for timing generation. In response to generation of the timing signal, the row driver 120 and the column scan circuit 150 are driven.

The row driver 120 connected to the timing generator 170 drives the pixel array 110 in units of rows. The row driver 120 can generate a row select signal for selecting any one row among a plurality of rows embodied in the pixel array 110.

Each of the plurality of active pixels in the active pixel area 112 senses incident light to output an active signal. Each of the plurality of active pixels in the active pixel area 112 can output an active reset signal.

Each of the plurality of optical black pixels in the optical black pixel area 114 can output an optical black reset signal and an optical black signal.

The current source circuit 130 may include an amplifying transistor and a source follower circuit. The current source circuit 130 is driven in response to a bias voltage to provide a constant current source.

The ramp signal generator 160 generates a ramp signal RS that is compensated for dark offset in response to a control signal CON. The ramp signal RS is applied to the CDS and ADC circuit 140 that performs A/D conversion.

The CDS and ADC circuit 140 receives an output of the pixel array 110 and performs CDS and ADC operations. A CDS circuit in the CDS and ADC circuit 140 can perform a dual correlated dual sampling on the received active reset signal and the received active signal. The CDS circuit can perform a dual correlated dual sampling on the received optical black reset signal and the received optical black signal.

An ADC circuit in the CDS and ADC circuit 140 converts a pixel signal corresponding to a charge accumulated in a photoelectric conversion device into a digital signal. The ADC circuit block compares correlated dual sampled signals being output from the current source circuit 130 with one another on the basis of a ramp signal generated from the ramp signal generator 160. The ADC circuit can output a clock signal responsive to the comparison.

A signal processor 200 includes a digital signal processor (DSP) and processes a digital output signal of the CDS and ADC circuit 140 on a horizontal output line (HOL) to generate a sensor output SOUT. The signal processor 200 generates the control signal CON based on the output signal of the CDS and ADC circuit 140 and applies the control signal CON to the ramp signal generator 160. The signal processor 200 is included in a dark offset compensation circuit compensating a dark offset using a dark offset and a gain setting value so that an input signal is processed only in a full range of an input signal level.

The embodiments shown in FIG. 1 are illustrative and the inventive subject matter is not limited thereto.

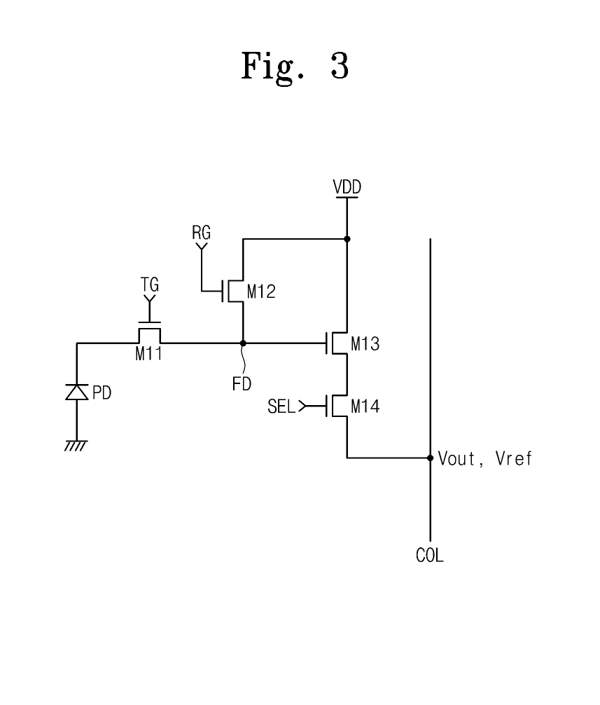

FIG. 3 is a detailed circuit diagram of a unit pixel of the pixel array 110 illustrated in FIG. 2.

Referring to FIG. 3, a pixel of an image sensor may include a photo diode PD and a 4-transistor structure including a transfer transistor M11, a reset transistor M12, a source follower transistor M13 and a select transistor M14. Although a 4-transistor structure is illustrated in FIG. 3, a pixel of an image sensor according to some embodiments may have a 3-transistor structure, a 5-transistor structure, a structure in which a plurality of pixels share a transistor circuit, etc.

In FIG. 3, if a gate voltage RG of the reset transistor M12 increases and thereby turns on the reset transistor M12, an electric potential of a floating diffusion node FD that serves as a sensing node is reset to a power supply voltage VDD. If light received from the outside enters the photo diode (PD) during an integration time period beginning after the reset transistor M12 is turned off, an electron hole pair (EHP) is generated in proportion to the entered light.

After the integration time period, if a gate voltage TG of the transfer transistor M11 increases, a charge accumulated in a photo diode region is transferred to the floating diffusion node FD. An electric potential of the floating diffusion node FD changes in proportion to the amount of transferred signal charges, and an electric potential of the source follower transistor M13 is changed.

When a gate voltage SEL of the select transistor M14 increases, the select transistor M14 is turned on. An electric potential of a source of the source follower transistor M13 is applied to a column line COL. The active pixels photoelectric-convert incident light to output a photo signal Vout and optical black pixels not receiving incident light output a reference signal Vref for a dark level compensation. The active pixels may have the same structure as the optical black pixels.

In FIG. 3, a photo diode PD is used as a photoelectric conversion device but a photo transistor, a photo gate, a pinned photo diode (PPD) or combinations thereof may be used as a photoelectric conversion device in some embodiments.

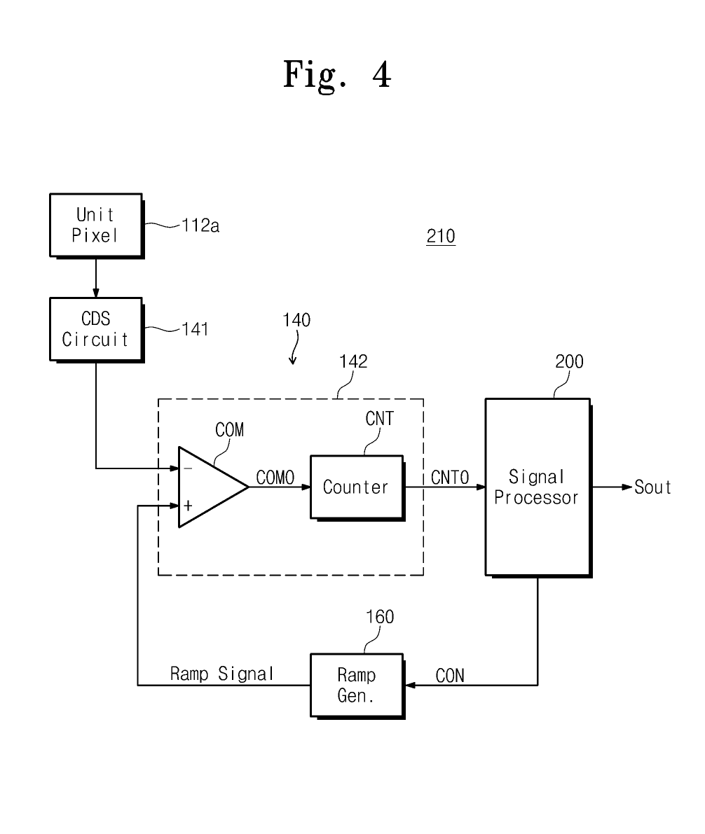

FIG. 4 is a block diagram illustrating the automatic dark level compensation (ADLC) circuit 210 including components illustrated in FIG. 1. In particular, FIG. 4 shows the CDS and ADC circuit 140 and a connection relation between the ramp signal generator 160 and the signal processor 200.

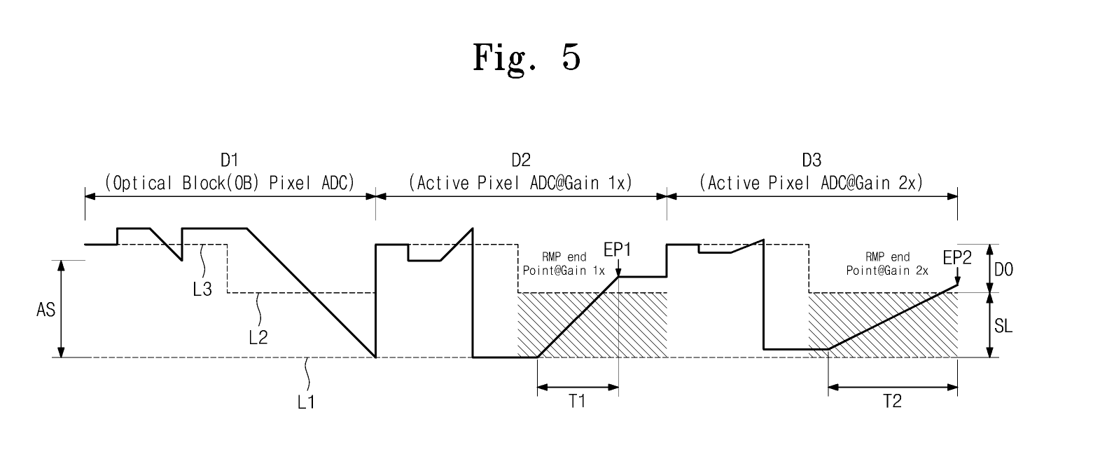

A detailed operation of FIG. 4 will be described with reference to FIGS. 5 through 7.

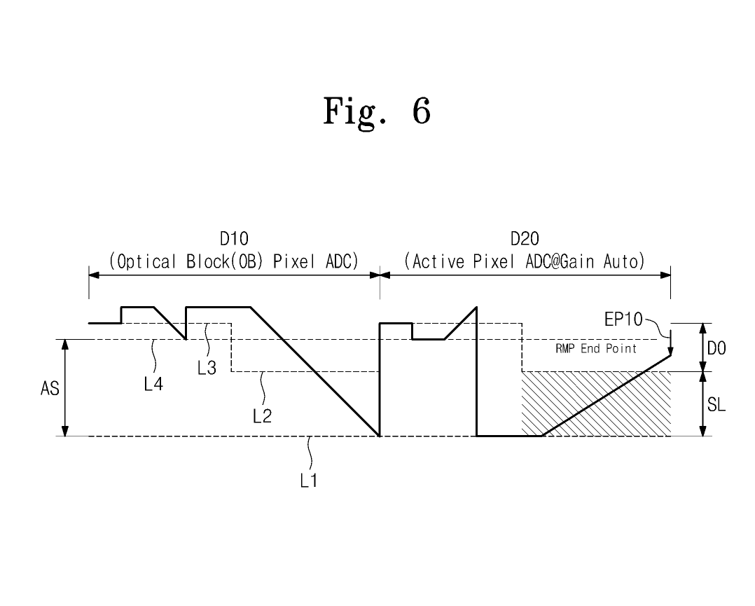

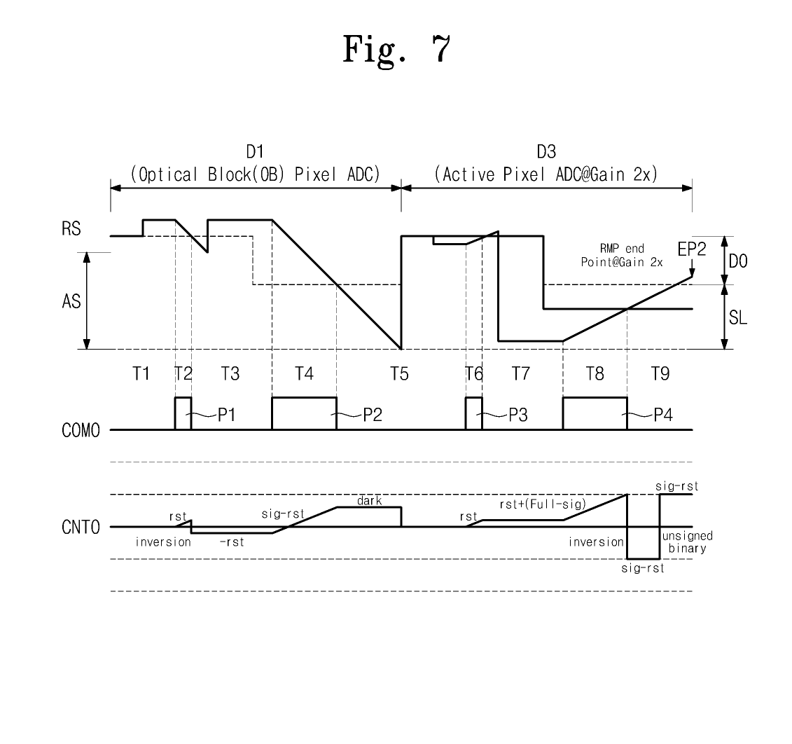

FIG. 5 is a timing diagram related to an automatic dark level compensation in accordance with some embodiments of the inventive subject matter. FIG. 6 is a timing diagram related to an automatic dark level compensation in accordance with some other embodiments of the inventive subject matter. FIG. 7 is a timing diagram related to an automatic dark level compensation in accordance with FIG. 4.

Referring to FIG. 5, a waveform of a ramp signal being generated for a compensation operation of a dark offset is illustrated. A waveform of the ramp signal illustrated in a period D1 is generated for an analog to digital conversion (ADC) of an optical black pixel and waveforms of the ramp signal illustrated in periods D2 and D3 are generated for an ADC of an active pixel.

The waveform of the ramp signal illustrated in the period D2 is generated for an ADC of the active pixel when a gain setting value of a comparator COM of FIG. 4 is 1× and the waveform of the ramp signal illustrated in the period D3 is generated for an ADC of the active pixel when a gain setting value of a comparator COM of FIG. 4 is 2×.

The waveforms of the ramp signal illustrated in the periods D2 and D3 are not generated below a level line L1 not to impose a burden on the circuit, that is, so that an input signal is processed only within a full range of an input signal level.

In some conventional systems, an offset is applied to a ramp signal to remove a dark offset. In this case, only a level of the dark offset is processed to be minus. Depending on a gain value, using a signal greater than ADC saturation, a single slope ADC may be performed. Thus, the circuit may bear a burden.

In the case of FIG. 5, since the ramp signal is not generated below the level line L1 indicating the maximum ADC saturation level of an input signal, a burden of the circuit is reduced or minimized. Since an automatic dark level compensation operation being performed by the automatic dark level compensation circuit 210 is sufficient to be performed only within a full range of an input signal level, the ramp signal does not need to be generated below the level line L1 indicating the maximum ADC saturation level of an input signal. The gain setting value may be a value previously stored in a memory of,the signal processor 200 of FIG. 4.

In FIG. 5, a voltage level between a level line L2 and a level line L3 represents a dark offset DO and a voltage level between a level line L1 and a level line L2 represents a signal input range SL. Reference numerals EP1 and EP2 indicate end points of the ramp signals respectively. In the case that a gain setting value is 1×, a slope of the ramp signal is obtained in a time period T1. In the case that a gain setting value is 2>, a slope of the ramp signal is obtained in a time period T2 wider than the time period T1. A character code AS indicates an ADC saturation range.

In FIG. 5, generation of the ramp signal is determined according to the dark offset and the gain setting value. A slope of the ramp signal being generated in the period D2 is steeper than a slope of the ramp signal being generated in the period D3. When comparing the waveforms being generated in the periods D2 and D3, as the gain setting value is greater, a slope of the ramp signal is reduced. Generation of the ramp signal is performed by a ramp signal generator 160 of FIG. 4. The ramp signal generator 160 generates a ramp signal according to the dark offset and the gain setting value in response to a control signal CON of the signal processor 200.

In FIG. 5, the ramp signal is formed by determining an end point of the ramp signal according to the dark offset, and then determining a start point of the ramp signal by a slope determined according to the gain setting value. In the case that the ramp signal does not reach the end point within the time period T1 or T2, the ramp signal is generated within a range smaller than the signal input range SL. In the case that the ramp signal reaches the end point within the time period T1 or T2, regardless of the dark offset, the input signal is located between Max (ADC Sat.)˜(ADC Sat.−dark offset), that is, at the signal input range SL indicated by hatching in FIG. 5.

Referring to FIG. 6, similar to FIG. 5, a waveform of the ramp signal illustrated in a period D10 is generated for an analog to digital conversion (ADC) of an optical black pixel and a waveform of the ramp signal illustrated in a period D20 is generated for an analog to digital conversion (ADC) of an active pixel.

The waveform of the ramp signal illustrated in the period D20 is generated for an analog to digital conversion (ADC) of an active pixel when a gain setting value of the comparator COM1 of FIG. 4 is automatically set.

Similarly, the waveforms of the ramp signal illustrated in the periods D10 and D20 are not generated below a level line L1 not to impose a burden on the circuit, that is, so that an input signal is processed only within a full range of an input signal level. In the case of FIG. 6, since an AUTOMATIC DARK LEVEL COMPENSATION operation is sufficient to be performed only within a full range of an input signal level, the ramp signal is not generated below the level line L1 indicating the maximum ADC saturation level of the input signal.

Since the gain setting value is automatically set by the signal processor 200, the dynamic range can be maximally obtained.

In FIG. 6, a voltage level between a level line L2 and a level line L3 represents a dark offset DO and a voltage level between the level line L1 and the level line L2 represents a signal input range SL. A reference numerical EP10 indicates an end point of the ramp signal. A range AS between the level line L1 and a level line L4 is an ADC saturation range.

In FIG. 5, when a dark offset due to a dark current occurs, an ADC Sat. is reduced by a dark offset. That is, AD-DO=SL. Thus, an input signal can be located in the range of Max (ADC Sat. :L1)-(ADC Sat.—dark offset:L2). That is, the range is the hatched area between the level line L1 and the level line L2.

In the case of FIG. 6, an end point EP10 of the ramp signal is determined by obtaining an ADC saturation level in which a level of the dark offset is reduced. By determining the maximum ADC saturation level of the input signal, a start point L1 of the ramp signal is determined. If setting a conversion time period of ADC to equal the hatches region, gain can be automatically set. That is, the gain may be properly set on the basis of the end point, the start point and the conversion time period. In that case, the ramp signal having a slope according to the gain set is generated and thereby a dynamic range may be maximized.

Referring to FIG. 7 illustrating operation timing related to an automatic dark level compensation in accordance with FIG. 4, showing an output waveform RS of the ramp signal is expressed by a waveform RS, an output waveform COMO of the comparator COM and an output waveform CNTO of a counter CNT.

In FIG. 7, the ramp signal RS in a period D1 is generated for an analog to digital conversion (ADC) of an optical black pixel and the ramp signal in a period D3 is generated for an analog to digital conversion (ADC) of an active pixel.

The ramp signal RS illustrated in the period D3 corresponds to the case that a gain setting value of the comparator COM1 of FIG. 4 is 2×.

The waveforms of the ramp signal illustrated in the periods D1 and D3 are not generated below a level line L1 indicating the maximum ADC saturation level of the input signal not to impose a burden on the circuit.

A comparator COM in an ADC block 142 receiving the ramp signal through its non-inverting terminal (+) and an output signal of a CDS block 141 through its inverting terminal performs a comparison operation according to a given gain. In a time period T2 of FIG. 7, a comparison output P1 is obtained as an output waveform COMO of the comparator COM. In time periods T4, T6 and T8, comparison outputs P2, P3 and P4 are obtained as output waveforms COMP of the comparator COM respectively.

In FIG. 7, the counter CNT of FIG. 4 counts outputs of the comparator using a set clock. An output of the counter CNT may be represented as a waveform CNTO. In a F-ADLC, referring to the period D3, to obtain the same difference between a signal count value and a reset count value as that in the period D1, output results of a signal count (full-signal; a result of counting in a minus direction), an inversion and a sign removal are sequentially illustrated through the waveform CNTO.

An effect due to a dark offset may be relatively great on a bulb mode supported in a digital still camera or a digital single-lens reflex (DSLR) camera. The bulb mode opens a shutter for the time that a user wants to provide long exposure time and may be used to shoot a trace image of a star in the sky or a headlight of vehicle that changes with time in low illumination. In some embodiments of the inventive subject matter, by selectively increasing a ramp signal like FIGS. 5, 6 and 7, operation performance in the bulb mode can be increased.

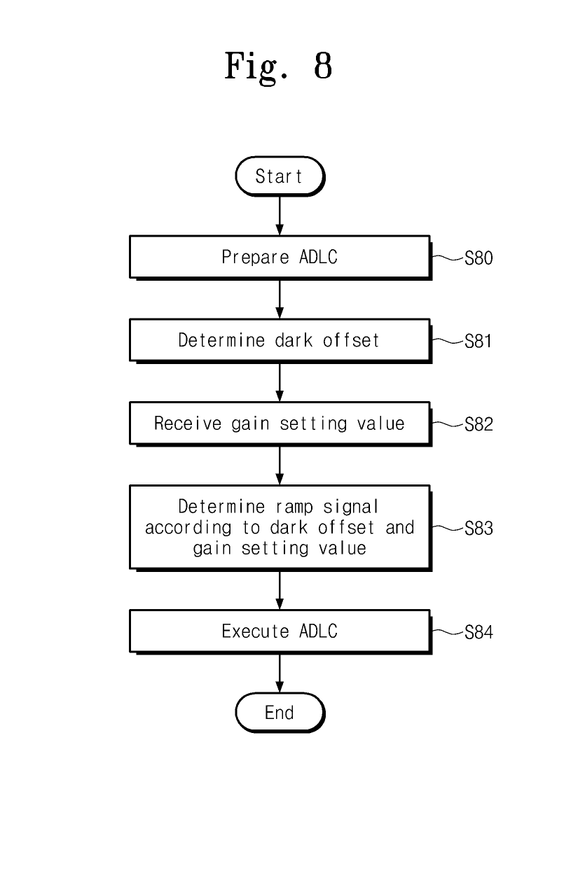

FIG. 8 is an operation control flow chart in accordance with FIG. 4 according some embodiments.

Referring to FIG. 8, in a step S80, an initialization operation for an AUTOMATIC DARK LEVEL COMPENSATION preparation is performed. After the initialization operation is performed, in a step S81, a level of a dark offset is determined. A level of the dark offset is determined using an output of an optical black pixel. In a step S82, a gain setting value is received. The signal processor 200 can receive a gain setting value previously stored in a memory. In a step S83, generation of a ramp signal is determined according to the dark offset and the gain setting value. As the gain setting value becomes great, a slope of the ramp signal being generated may be reduced and as the gain setting value becomes small, a slope of the ramp signal being generated may be increased. In a step S84, an automatic dark level compensation is executed in an A/D conversion operation. Since the circuit operates within only a full range of a photo signal, a circuit burden may be reduced or minimized.

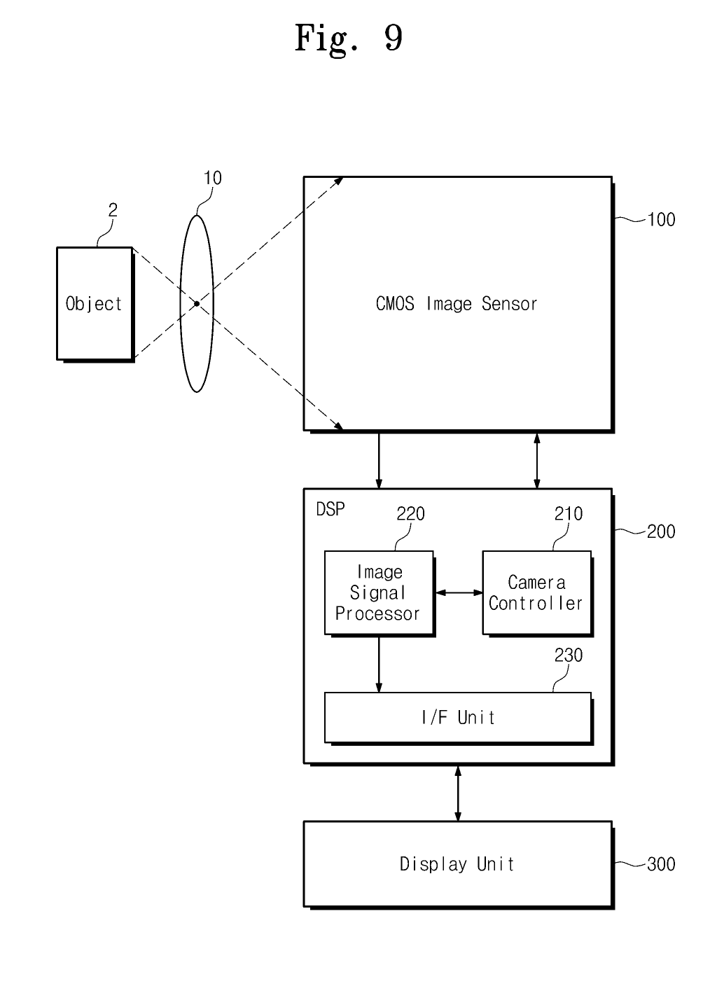

FIG. 9 is a block diagram illustrating a camera in which the inventive subject matter is applied.

Referring to FIG. 9, the camera includes a CMOS image sensor 100 having a dark offset compensation function, a digital signal processor (DSP) 200 and a display unit 300.

The CMOS image sensor 100 senses an object 2 shot through a lens 10 according to a control of the digital signal processor (DSP) 200. The DSP 200 can process image signals sensed by the image sensor 100 to output the image signals to the display unit 300.

The display unit 300 includes all devices that can output or display the image signals. The display unit 300 may mean a computer, a mobile communication device and an image output termination. The display unit 300 is a liquid crystal having a backlight, a liquid crystal having a LED light source or an OLED and may have a touch screen.

The DSP 200 includes a camera controller 210, an image signal processor (ISP) and an interface unit 230. The DSP 200 may further include a memory. According to a constitution of FIG. 9, since a CMOS image sensor 100 having a dark offset compensation function like the embodiments of the inventive subject matter is included in a camera, a burden of the circuit is reduced or minimized. Also, a dynamic range of the circuit operation may be maximized or increased.

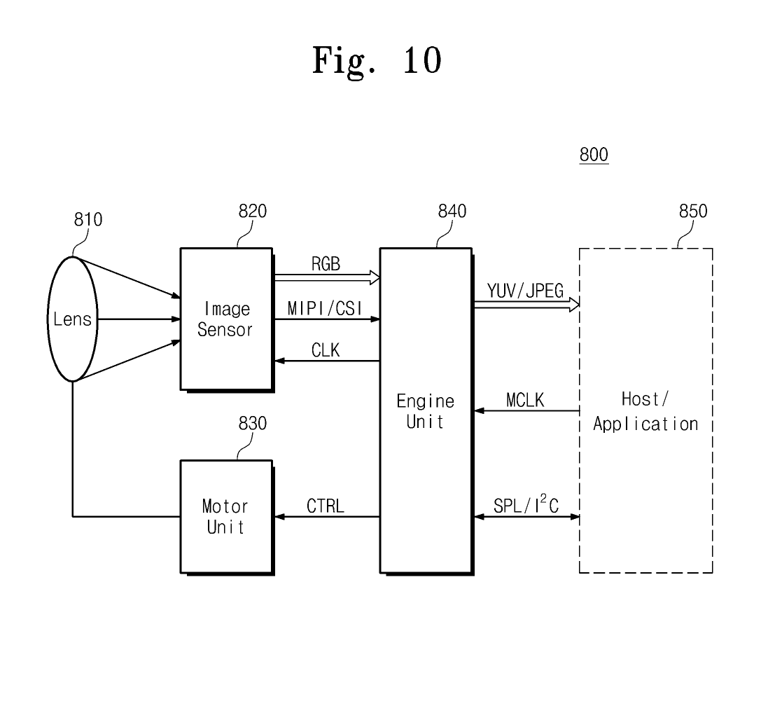

FIG. 10 is a drawing illustrating an example of some, embodiments of the inventive subject matter applied to a digital camera.

Referring to FIG. 10, a digital camera 800, such as a DSLR camera, may include a lens 810, an image sensor 820, a motor unit 830 and an engine unit 840. The image sensor 820 includes an image sensor effectively compensating a dark offset according to some embodiments of the inventive subject matter.

The lens 810 concentrates an incident light on a light receiving area of the image sensor 820. The image sensor 820 can generate RGB data of a Bayer pattern on the basis of light which entered through the lens 810. The image sensor 820 can provide RGB data on the basis of a clock signal CLK.

The image sensor 820 can interface with the engine unit 840 through a mobile industry processor interface (MIPI) or a camera serial interface (CSI). The motor unit 830 may control a focus of the lens 810 or perform a shuttering in response to a control signal CTRL received from the engine unit 840. The engine unit 840 controls the image sensor 820 and the motor unit 830. On the basis of RGB data received from the image sensor 820, the engine unit 840 may generate UUV data including a luminance component, a difference between the luminance component and a blue component and a difference between the luminance component and a red component or may generate compressed data, for example, joint photography experts group (JPEG).

The engine unit 840 may be connected to a host/application 850 and may provide the YUV data or the JPEG data to the host/application 850 on the basis of a master clock MCLK. The engine unit 840 may interface with the host/application 850 through a serial peripheral interface (SPI) or an inter integrated circuit (I²C).

According to the camera constitution of FIG. 10, since the image sensor 820 having a dark offset compensation function is included in the camera, a burden of circuit constitution is minimized or reduced. A dynamic range of the circuit operation may be maximized or increased.

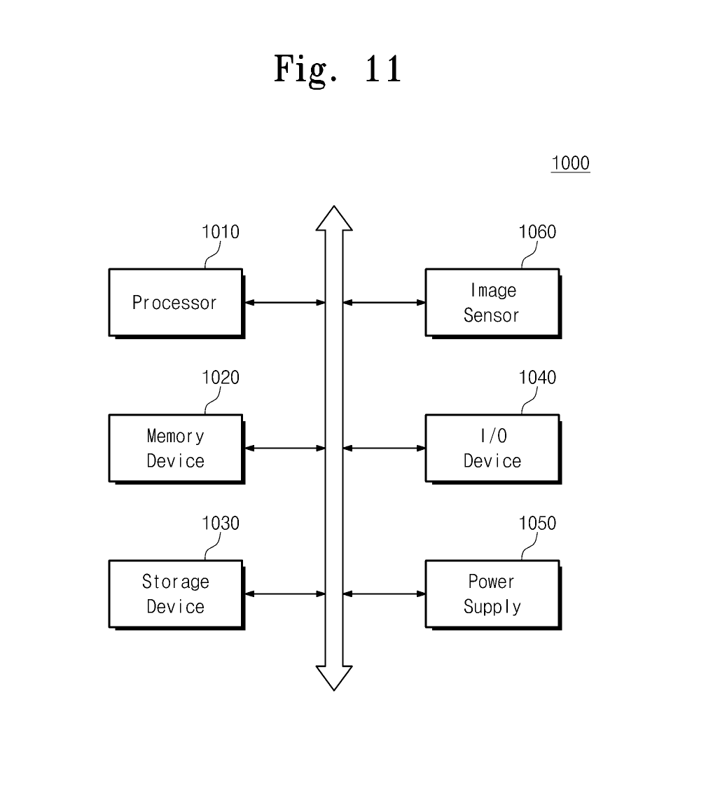

FIG. 11 is a drawing illustrating an example of some embodiments of the inventive subject matter applied to a computing system.

Referring to FIG. 11, a computing system 1000 includes a processor 1010, a memory device 1020, a storage device 1030, an input/output device 1040, a power supply 1050 and an image sensor 1060.

The image sensor 1060 includes an image sensor performing an offset compensation function in accordance with some embodiments of the inventive subject matter. Although not illustrated in FIG. 11, the computing system 1000 may further include ports that can communicate with a video card, a sound card, a memory card, a USB device or other electronic devices.

The processor 1010 can perform specific calculations or specific tasks. According to the embodiments, the processor 1010 may be a micro-processor or a central processing unit (CPU).

The processor 1010 can communicate with the memory device 1020, the storage device 1030 and the input/output device 1040 through an address bus, a control bus and a data bus.

The processor 1010 may be connected to an extension bus such as a peripheral component interconnection (PCI) bus.

The memory device 1020 can store data necessary for an operation of the computing system 1000. The memory device 1020 may includes a DRAM, a mobile DRAM, a SRAM or a nonvolatile memory device.

The nonvolatile memory may be embodied by an electrically erasable programmable read-only memory (EEPROM), a flash memory, a magnetic random access memory (MRAM), a spin-transfer torque MRAM, a conductive bridging RAM (CBRAM), a ferroelectric RAM (FeRAM), a phase change RAM (PRAM) which is called an ovonic unified memory (OUM), a resistive RAM (RRAM), a nanotube RRAM, a polymer RAM (PoRAM), a nanotube floating gate memory (NFGM), a holographic memory, a molecular electronics memory device, or an insulator resistance change memory.

Chips of the memories may be mounted using various types of packages such as PoP (package on package), ball grid array (BGA), chip scale package (CSP), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline (SOIC), shrink small outline package (SSOP), thin small outline (TSOP), thin quad flatpack (TQFP), system in package (SIP), multi chip package (MCP), wafer-level fabricated package (WFP) and wafer-level processed stack package (WSP).

The storage device 1030 may include a solid state drive (SSD), a hard disk drive (HDD), a CD-ROM, etc.

The input/output device 1040 may include an input means such as a keyboard, a keypad, a mouse, etc. and an output unit such as a printer and a display. The power supply 1050 can supply an operation voltage necessary for an operation of the computing system 1000.

The image sensor 1060 is connected to the processor 1010 through buses or other communication links to communicate with the processor 1010. As described above, the image sensor 1060 can generate image data having high image quality in an exposure environment of low illumination and long time by compensating a dark level compensation using a dark offset and gain setting information. The image sensor 1060 can be integrated in one chip together with the processor 1010 or the image sensor 1060 and the processor 1010 can be integrated in different chips respectively.

The computing system 1000 may any of a number of different types of computing systems that use an image sensor. The computing system 1000 may include a digital camera, a mobile phone, a personal digital assistant (PDA), a portable multimedia player (PMP), a smart phone, a tablet PC, etc.

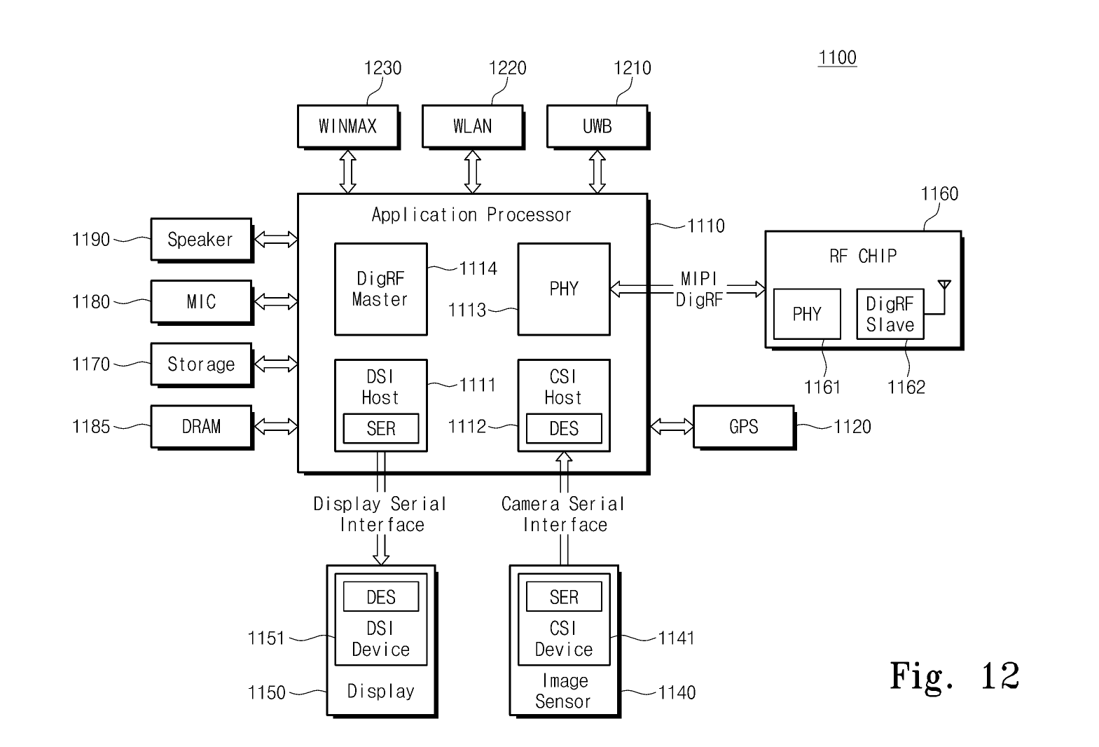

FIG. 12 is a drawing illustrating an example of some embodiments of the inventive subject matter applied to a cellular phone.

Referring to FIG. 12, the cellular phone 1100 may includes a data processing device that can use or support a MIPI interface and may include an application processor 1110, an image sensor 1140 and a display 1150, etc.

A CSI host 1112 of the application processor 1110 can perform a serial communication with a CSI device 1141 of the image sensor 1140 through a camera serial interface (CSI).

The CSI host 1112 may include a deserializer (DES) and the CSI device 1141 may include a serializer (SER). A DSI host 1111 of the application processor 1110 can perform a serial communication with a DSI device 1151 through a display serial interface (DSI).

The DSI host 1111 may include a serializer SER and the DSI DEVICE 1151 may include a deserializer. Further, the cellular phone 1100 may further include a radio frequency (RF) chip 1160 that can perform a communication with the application processor 1110. A PHY 1113 of the cellular phone 1100 and a PHY 1161 of the RF chip 1160 can perform a data transmit/receive according to a mobile industry processor interface (MIPI) DigRF.

The application processor 1110 may further include a DigRF MASTER 1114 controlling a data transmit/receive according to the MIPI DigRF of PHY 1161. The cellular phone 1100 may include a global positioning system (GPS) 1120, a storage 1170, a mike 1180, a dynamic random access memory (DRAM) 1185 and a speaker 1190.

The cellular phone 1100 can perform a communication using an ultra wideband (UWB) 1210, a wireless local area network (WLAN) 1220 and a worldwide interoperability for microwave access (WIMAX) 1230. A structure and an interface of the cellular phone 1100 is only an illustration and the inventive subject matter is not limited thereto.

Since the image sensor 1140 has a function compensating a dark offset using a dark offset and a gain setting value according to some embodiments of the inventive subject matter so that an input signal is processed only within a full range of an input signal level, a burden of circuit constitution in the cellular phone system is minimized or reduced. A dynamic range of a circuit operation may be maximized or increased.

The above-disclosed subject matter is to be considered illustrative, and not restrictive, and the appended claims are intended to cover all such modifications, enhancements, and other embodiments, which fall within the true spirit and scope of the inventive subject matter. Thus, to the maximum extent allowed by law, the scope of the inventive subject matter is to be determined by the broadest permissible interpretation of the following claims and their equivalents, and shall not be restricted or limited by the foregoing detailed description.

What is claimed is:

1. A solid state imaging device comprising:
a pixel array comprising a plurality of photoelectric conversion devices;
an analog to digital conversion (ADC) circuit configured to convert an image signal received from the pixel array to a digital signal responsive to a ramp signal and a gain setting;
a ramp signal generator circuit configured to generate the ramp signal with a slope that varies responsive to a control signal; and
a dark level offset compensation circuit configured to generate the control signal responsive to the gain setting and a dark level measurement.

2. The solid state imaging device of claim 1, wherein the pixel array comprises at least one optical black pixel and wherein the dark level measurement is generated from an output of the at least one optical black pixel.

3. The solid state imaging device of claim 3, wherein the ADC circuit comprises:
a comparator configured to generate a comparison signal responsive to the image signal and the ramp signal; and
a counter configured to generate a count signal responsive to the comparison signal.

4. The solid state imaging device of claim 3, wherein again of the comparator is controlled by the gain setting.

5. The solid state imaging device of claim 4, wherein the dark level offset compensation circuit is configured to cause the ramp signal generator to decrease the slope of the ramp signal responsive to a gain setting that increases the gain of the comparator and to increase the slope of the ramp signal responsive to a gain setting that decreases the gain of the comparator is decreased.

6. The solid state imaging device of claim 1, wherein the ramp signal generator is constrained to be greater than a maximum ADC saturation level of ADC converter.

7. An apparatus comprising:
an analog to digital conversion (ADC) circuit configured to convert an image signal received from a photoelectric conversion device to a digital signal responsive to a ramp signal and a gain setting;
a ramp signal generator circuit configured to generate the ramp signal with a slope that varies responsive to a control signal; and
a control circuit configured to determine the gain setting based on a dark level measurement and a conversion time period of the ADC circuit and to generate the control signal based on the determined gain setting.

8. The apparatus of claim 7, wherein the ADC circuit comprises:
a comparator configured to generate a comparison signal responsive to the image signal and the ramp signal; and
a counter configured to generate a count signal responsive to the comparison signal,
wherein a gain of the comparator is controlled by the gain setting.

9. The apparatus of claim 8, wherein the dark level offset compensation circuit is configured to cause the ramp signal generator to decrease the slope of the ramp signal responsive to a gain setting that increases the gain of the comparator and to increase the slope of the ramp signal responsive to a gain setting that decreases the gain of the comparator is decreased.

10. A method of operating a solid state imaging device including a pixel array comprising a plurality of photoelectric conversion devices, an analog to digital conversion (ADC) circuit configured to convert an image signal received from the pixel array to a digital signal responsive to a ramp signal and a gain setting and a ramp signal generator circuit configured to generate the ramp signal with a slope and offset that varies responsive to a control signal, the method comprising:
determining a first value for the ramp signal based on a dark level offset;
determining a second value for the ramp signal based on a maximum saturation level of the input to the ADC circuit;
determining a conversion time period of the ADC circuit;
determining a gain for the ADC circuit based on the first value, the second value and the conversion time period;
generating the ramp signal with a slope based on the determined gain; and
converting the image signal into a digital signal responsive to the ramp signal using the ADC circuit with the determined gain.

12. The method of claim 11, wherein the first value corresponds to a start point for the ramp signal and wherein the second value corresponds to an end point for the ramp signal.

13. The method of claim 11, wherein determining a gain for the ADC circuit based on the first value, the second value and the conversion time period comprises determining a gain for a comparator that generates a comparison signal responsive to the image signal and the ramp signal.

14. The method of claim 11, further comprising determining the dark level offset responsive to an output of an optical black pixel in the pixel array.

15. The method of claim 11, further comprising preventing the ramp signal from being less than a maximum ADC saturation level of the input signal.

16. The method of claim 11, wherein the input signal is applied between the ADC saturation level from which a level of a dark offset is subtracted and the maximum ADC saturation level of the input signal.
